(19) United States
(12) Patent Application Publication
(10) Pub. No.: US 2023/0297144 A1
(43) Pub. Date: Sep. 21, 2023

(54) ELECTRONIC APPARATUS

(71) Applicant: Lenovo (Singapore) Pte. Ltd., Singapore (SG)

(72) Inventors: Hiroaki Kinoshita, Kanagawa (JP); Takehito Yamauchi, Kanagawa (JP); Shigehiro Horiuchi, Kanagawa (JP); Takayuki Morino, Kanagawa (DE)

(73) Assignee: Lenovo (Singapore) Pte. Ltd., Singapore (SG)

(21) Appl. No.: 18/176,469

(22) Filed: Feb. 28, 2023

(30) Foreign Application Priority Data
Mar. 17, 2022 (JP) 2022-042227

(51) Int. Cl. G06F 1/16; H04M 1/02

(52) U.S. Cl. CPC G06F 1/1656; G06F 1/1616; G06F 1/1681; G06F 1/169; H04M 1/0216; H04M 1/0266

(57) ABSTRACT

An electronic apparatus includes a display having a folding region that is folded according to relative rotation of a first chassis and a second chassis and a sheet-shaped member fixed to cover a rear surface of the display. In the sheet-shaped member, a first slit row including a plurality of first slits arranged at equal intervals along a Y direction and a second slit row including a plurality of second slits arranged at equal intervals along an X direction are provided. A plurality of first slit rows and a plurality of the second slit row are provided at equal intervals along the X direction and the Y direction. In a first pattern formed by the first slit row and the second slit row, the first slit and the second slit form an intermittent lattice shape.

### CROSS-REFERENCE TO RELATED APPLICATIONS

This application claims priority to Japanese Patent Application No. 2022-42227 filed on Mar. 17, 2022, the contents of which are hereby incorporated herein by reference in their entirety.

### BACKGROUND OF THE INVENTION

### Field of the Invention

The present invention relates to an electronic apparatus including a foldable display.

### Description of the Related Art

In recent years, electronic apparatuses such as tablet PCs and smartphones that have a touch panel type liquid crystal display and do not have a physical keyboard are rapidly spreading. The display of this type of electronic apparatus is desired to be large when in use, but it is desired to be small for portable use. Therefore, an electronic apparatus configured such that not only a chassis but also a display is capable of being folded by using a flexible display such as organic Electro Luminescence (EL) has become practical.

Since the flexible display by itself lacks strength, it is desirable to laminate sheet-shaped members. It has been proposed that the sheet-shaped member is provided with a number of holes for the purpose of making it easy to bend and reducing the weight (see, for example, Japanese Unexamined Patent Application Publication No. 2021-131812).

The flexible display as described above may be a touch panel type corresponding to pen input. In a case of pen input, it is preferable that there is an appropriate resistance between the flexible display and a pen tip, as in a case of writing on paper. In addition, it is desirable that such a resistance can be obtained uniformly regardless of a moving direction of the pen tip.

By the way, in a case in which the sheet-shaped member is provided with a hole as described above, when a front surface of the flexible display covering the sheet-shaped member is slid with the pen tip, it is possible to give a user a feel of going over a slight step when passing a portion of edge of the hole. Although the sheet-shaped member is provided with a number of holes, the purpose is to reduce the weight and the like. The size, shape, arrangement, and the like do not realize the resistance of the pen. Therefore, the user may feel uncomfortable due to uneven level difference.

### SUMMARY OF THE INVENTION

One or more embodiments of the invention provide an electronic apparatus capable of giving a preferable feel to the user in pen input.

An electronic apparatus according to an aspect of the present invention includes: a first chassis; a second chassis adjacent to the first chassis and relatively rotatably connected to the first chassis; a display provided over the first chassis and the second chassis and having a folding region that is folded according to relative rotation of the first chassis and the second chassis; and a sheet-shaped member having a flexibility and is fixed to a rear surface of the display to cover the rear surface, in which the sheet-shaped member is provided with a first slit row including a plurality of first slits arranged at equal intervals along a first direction and a second slit row including a plurality of second slits arranged at equal intervals in a second direction that is orthogonal to the first direction, a plurality of the first slit rows are provided at equal intervals along the second direction, a plurality of the second slit rows are provided at equal intervals along the first direction, and in a pattern formed by the plurality of first slit rows and the plurality of second slit rows, the first slit and the second slit form an intermittent lattice shape. Accordingly, it is possible to give the user a preferable feel in pen input.

The pattern may be provided at a portion excluding a portion that covers the folding region, in the portion covering the folding region, a plurality of third slit rows may be provided, the third slit row including third slits that are arranged at equal intervals along a third direction along an edge where the first chassis and the second chassis face each other, and an interval between the third slit rows may be narrower than an interval between the first slit rows and an interval between the second slit rows. Accordingly, it becomes easier to bend the display in a proper direction.

The first slit and the second slit may intersect each other and may form a cross slit.

The first slit and the second slit may have a same length, and intervals between the plurality of first slit rows and intervals between the plurality of second slit rows may be equal. Accordingly, a more uniform interval can be obtained regardless of a moving direction of the pen tip.

The first slits may be disposed in a staggered manner between the adjacent first slit rows, and the second slits may be disposed in a staggered manner between the adjacent second slit rows. As described above, when the first slits and the second slits are disposed in a staggered manner, the interval between the first slit row and the second slit row can be narrow and tight.

The above-described aspects of present invention enable that the frequency of going over the first slit and the second slit is almost the same, and a uniform and the appropriate resistance can be obtained regardless of the difference in the moving direction even in a case in which the pen tip follows any of a trajectory along the first direction, a trajectory along the second direction, and trajectories along a diagonal direction with respect to the first direction and the second direction. In addition, such a resistance is similar to a case of writing on paper, and it is possible to perform pen input without feeling uncomfortable, and it is possible to give a preferable feel to the user.

### BRIEF DESCRIPTION OF THE DRAWINGS

FIG. 1 is a perspective view illustrating a state in which an electronic apparatus according to one or more embodiments is closed and has a folded form.

FIG. 2 is a plan view schematically illustrating a state in which the electronic apparatus illustrated in FIG. 1 is opened and has a flat plate form.

FIG. 3A is a side sectional view schematically illustrating an internal structure of an electronic apparatus in a folded form.

FIG. 3B is a side sectional view illustrating a state in which the chassis are being rotated toward a flat plate form from the state illustrated in FIG. 3A.

FIG. 3C is a side sectional view of the electronic apparatus illustrated in FIG. 3A in a flat plate form.

FIG. 4 is a schematic side sectional view of a display assembly.

FIG. 5 is a plan view schematically illustrating a state of a sheet-shaped member in a flat plate form.

FIG. 6 is a partially enlarged plan view of a portion of the sheet-shaped member that covers a folding region of a display.

FIG. 7 is a view illustrating a first pattern formed on a portion of the sheet-shaped member that covers regions RA and RB of the display.

FIG. 8 is a view illustrating a second pattern.

FIG. 9 is a view illustrating a third pattern.

FIG. 10 is a view illustrating a fourth pattern.

### DETAILED DESCRIPTION OF THE INVENTION

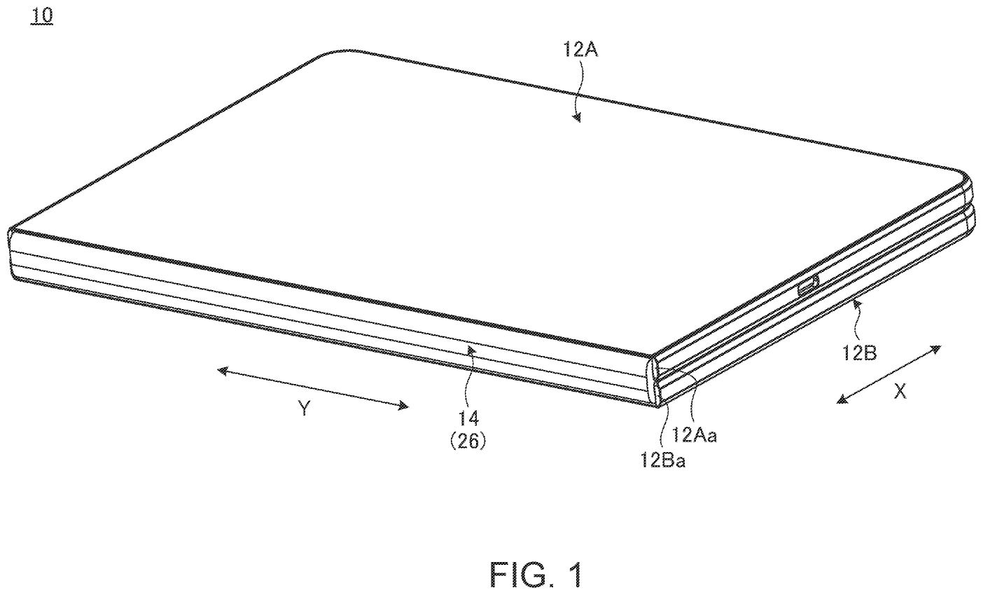

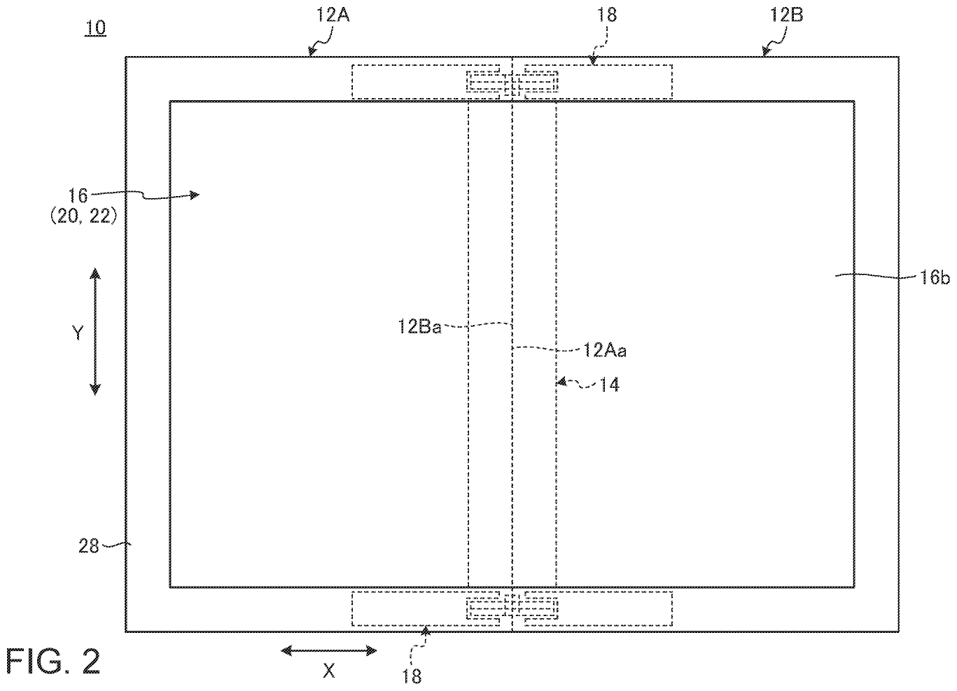

FIG. 1 is a perspective view illustrating a state in which an electronic apparatus 10 according to one or more embodiments is closed and has a folded form. FIG. 2 is a plan view schematically illustrating a state in which the electronic apparatus 10 illustrated in FIG. 1 is opened and has a flat plate form. As illustrated in FIGS. 1 and 2, the electronic apparatus 10 includes a first chassis 12A and a second chassis 12B, a rear cover member 14, and a display assembly 16. In one or more embodiments, a tablet PC that is capable of being folded like a book is exemplified as the electronic apparatus 10. The electronic apparatus 10 may be a mobile phone, a smartphone, a portable game machine, or the like.

Each of the chassis 12A and 12B is disposed adjacent to each other. Each of the chassis 12A and 12B is formed of a rectangular plate-shaped member having side walls upright on three sides other than the sides (adjacent end portions 12Aa and 12Ba) corresponding to the rear cover member 14, respectively. Each of the chassis 12A and 12B is made of, for example, a metal plate such as stainless steel, magnesium, or aluminum, or a fiber-reinforced resin plate containing reinforcing fibers such as carbon fiber, and the like. The rear cover member 14 is a member that hides a gap between the adjacent end portions 12Aa and 12Ba formed in a folded form illustrated in FIG. 1. The display assembly 16 extends over the chassis 12A and 12B.

Hereinafter, as illustrated in FIGS. 1 and 2, as for the electronic apparatus 10, description is performed while a direction in which the chassis 12A and 12B are aligned is called an X direction, and a direction along the adjacent end portions 12Aa and 12Ba orthogonal to the X direction is called a Y direction.

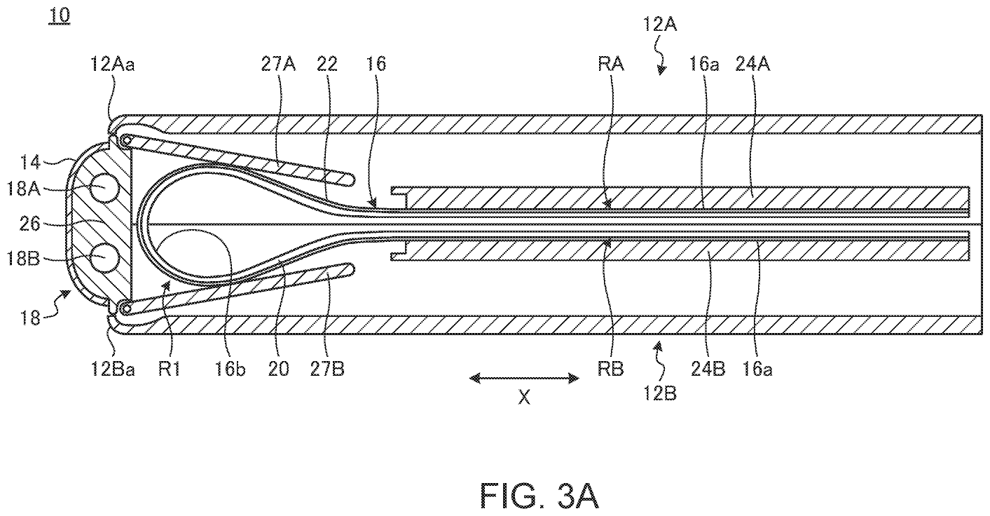

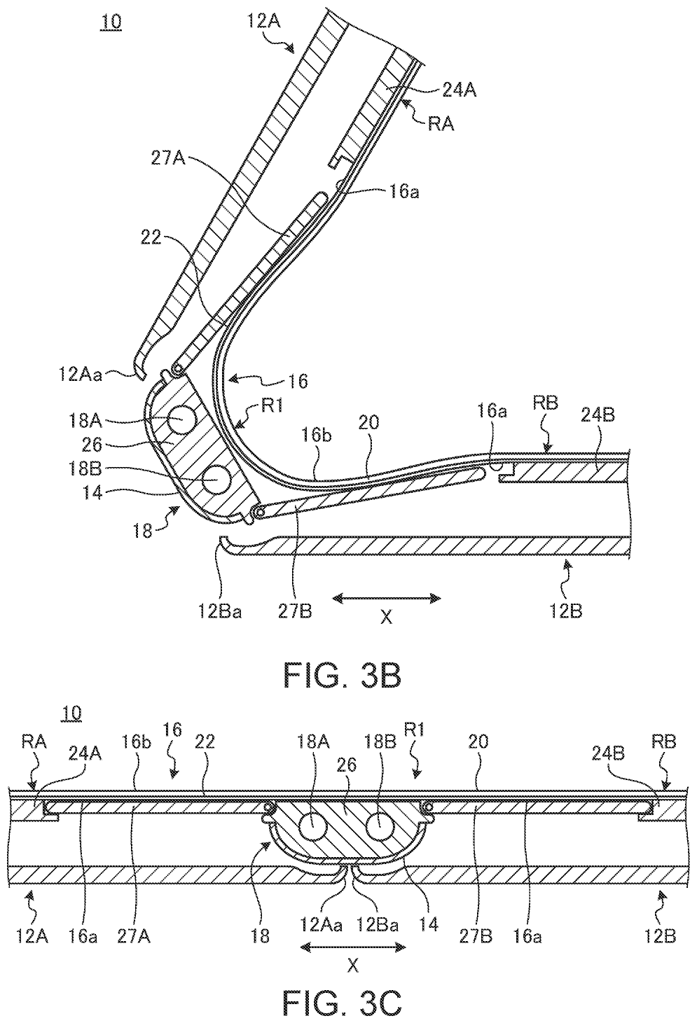

FIG. 3A is a side sectional view schematically illustrating an internal structure of the electronic apparatus 10 in a folded form. FIG. 3B is a side sectional view illustrating a state in which the chassis 12A and 12B are being rotated toward a flat plate form from the state illustrated in FIG. 3A. FIG. 3C is a side sectional view of the electronic apparatus 10 illustrated in FIG. 3A in a flat plate form.

As illustrated in FIGS. 1 to 3C, between the chassis 12A and 12B, the adjacent end portions 12Aa and 12Ba are connected by a pair of hinge mechanisms 18 provided at both end portions in the Y direction. As illustrated in FIGS. 3A to 3C, the hinge mechanism 18 connects the chassis 12A and 12B so as to be relatively rotatable in the folded form illustrated in FIG. 1 and the flat plate form illustrated in FIG. 2.

In the folded form, the chassis 12A and 12B are disposed to overlap each other. At this time, the display assembly 16 is in a state in which a region RA on a side of the first chassis 12A and a region RB on a side of the second chassis 12B are disposed so as to face each other, and a folding region R1 that is an intermediate region between the regions RA and RB is folded (see FIG. 3A). That is, the folding region R1 is provided at a position between the left and right end portions of the rectangular sheet-shaped display assembly 16. In the flat plate form, the chassis 12A and 12B are disposed side by side in an in-plane direction. At this time, the regions RA, RB, and the folding region R1 are disposed side by side in the in-plane direction in the display assembly 16, and the display assembly 16 has a flat plate shape as a whole (see FIGS. 2 and 3C).

As illustrated in FIGS. 3A to 3C, the display assembly 16 has a structure in which a display 20 and a sheet-shaped member 22 are laminated.

In the display assembly 16, the region RA is relatively fixed with respect to the first chassis 12A, and the region RB is relatively fixed with respect to the second chassis 12B. In one or more embodiments, in the region RA, a rear surface 16a is supported by a first plate 24A and is fixed to the first chassis 12A via the first plate 24A. In the region RB, the rear surface 16a is supported by a second plate 24B and is fixed to the second chassis 12B via the second plate 24B. Each of the plates 24A and 24B is fixed to the chassis 12A and 12B with screws or the like. The folding region R1 is in a state of being relatively movable with respect to the chassis 12A and 12B.

As illustrated in FIGS. 3A to 3C, the hinge mechanism 18 of one or more embodiments has a hinge main body 26, a first auxiliary plate 27A, and a second auxiliary plate 27B.

The hinge main body 26 is provided at a position straddling the adjacent end portions 12Aa and 12Ba of the chassis 12A and 12B (see FIG. 3C) and is a rod-shaped member that extends in the Y direction. The rear cover member 14 is disposed so as to cover an outer surface of the hinge main body 26. The hinge main body 26 may function as the rear cover member 14 as it is. The hinge main body 26 supports two hinge shafts 18A and 18B that are aligned in the X direction in the flat plate form. The hinge shaft 18A is connected to the first chassis 12A via a link member or the like (not illustrated). The hinge shaft 18B is connected to the second chassis 12B via a link member or the like (not illustrated). In the first auxiliary plate 27A, an end portion on the adjacent end portion 12Aa side is rotatably connected to the hinge main body 26 by a rotation shaft. In the second auxiliary plate 27B, an end portion on the adjacent end portion 12Ba side is rotatably connected to the hinge main body 26 by the rotation shaft.

The hinge mechanism 18 connects the chassis 12A and 12B so as to be rotatable in the folded form illustrated in FIG. 3A and the flat plate form illustrated in FIG. 3C as above configuration. The center of rotation of the hinge mechanism 18 coincides with the front surface 16b of the display assembly 16. The configuration of the hinge mechanism 18 may be changed as appropriate.

Therefore, in the folded form illustrated in FIG. 3A, the regions RA and RB of the display assembly 16 are supported by the plates 24A and 24B. At this time, the folding region R1 has a substantially bell shape (substantially bulb shape) in a side view in a state of being included in the hinge main body 26 and the auxiliary plates 27A and 27B. On the other hand, in the flat plate form illustrated in FIG. 3C, the plates 24A and 24B, the hinge main body 26, and the auxiliary plates 27A and 27B are aligned in the in-plane direction, and the front surfaces of them are disposed to be flush with each other to form a flat plate as a whole. Therefore, in the display assembly 16, the rear surface 16a is supported on the flat plate, and one flat plate-shaped large screen is formed. Reference numeral 28 in FIG. 2 is a bezel member, and is a frame-shaped cover member for an inactive region on a peripheral edge portion of a front surface 16b of the display assembly 16.

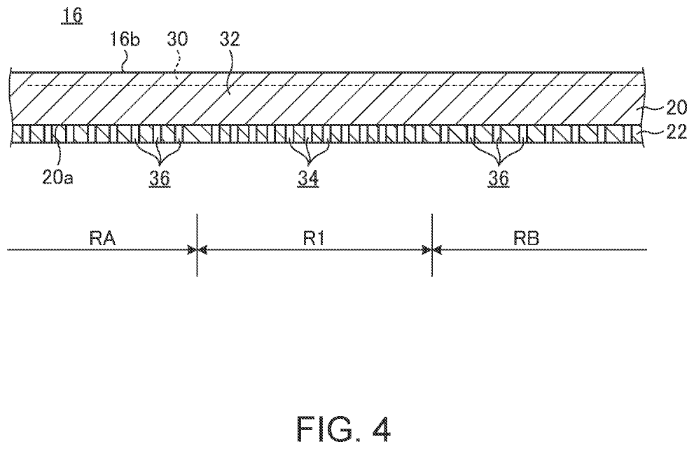

Next, a specific configuration example of the display assembly 16 will be described. FIG. 4 is a schematic side sectional view of the display assembly 16.

As illustrated in FIG. 4, the display assembly 16 has a structure in which the sheet-shaped member 22 is laminated on the rear surface 20a of the display 20 located on the front surface 16b side.

The display 20 has, for example, a structure in which a transparent front surface protective film forming the front surface 16b, a touch panel 30, a liquid crystal member 32, and a rear surface film forming the rear surface 20a are laminated. The touch panel 30 is a capacitance type that corresponds to a touch operation by a pen input device such as a digitizer pen and a touch operation by a human fingertip. The liquid crystal member 32 is, for example, an organic EL. The display 20 has a highly flexible paper structure as a whole.

The sheet-shaped member 22 is a flexible thin sheet fixed to the rear surface 20a with a double-sided tape, an adhesive, or the like so as to cover the rear surface 20a of the display 20. For example, the sheet-shaped member 22 is made of a metal sheet such as stainless steel with a number of third slits 34 and a number of cross slits 36. The sheet-shaped member 22 has a certain degree of tension and is used to secure the same radius of curvature as the design specifications when the display assembly 16 is folded. That is, the entire display assembly 16 has a flexible structure.

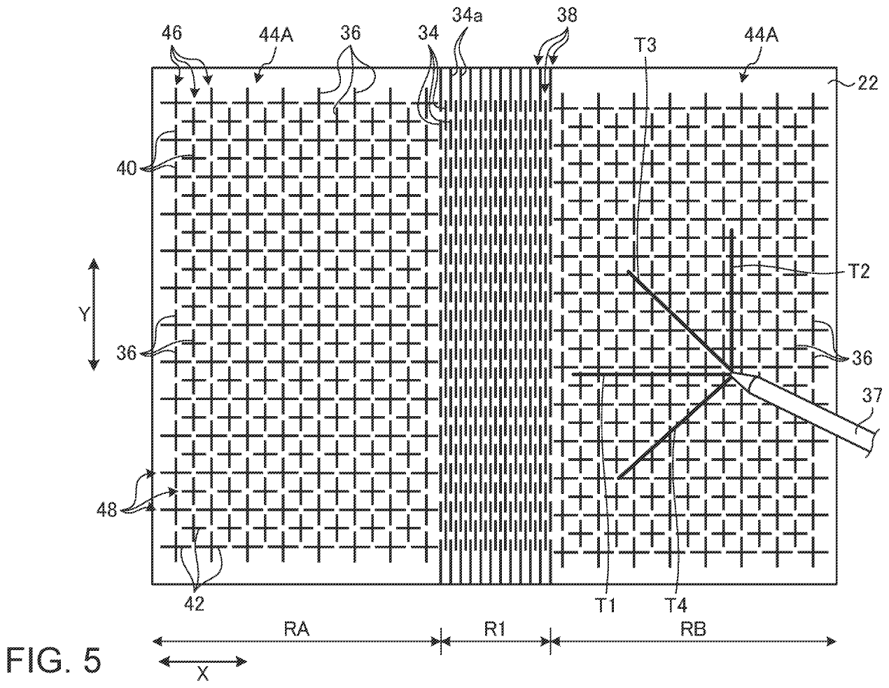

FIG. 5 is a plan view schematically illustrating a state of the sheet-shaped member 22 in the flat plate form. The third slit 34 is formed in the folding region R1, and the cross slit 36 is formed in the other regions RA and RB. The third slit 34 and the cross slit 36 are formed by etching, punching, or the like. The widths of the third slit 34 and the cross slit 36 are preferably smaller than at least an outer diameter (for example, about 1 mm) of the pen tip of the pen input device 37 used in the electronic apparatus 10. The target for input by the pen input device 37 is the display 20, but in FIG. 5, the pen input device 37 is illustrated on the sheet-shaped member 22 for easy understanding.

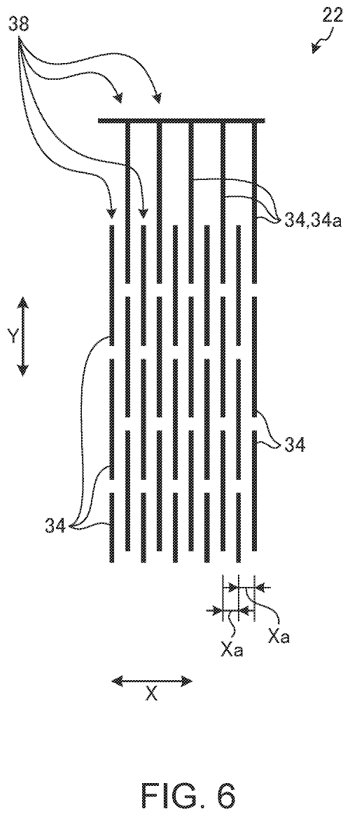

FIG. 6 is a partially enlarged plan view of a portion of the sheet-shaped member 22 that covers the folding region R1 of the display 20. The third slit 34 is formed at this portion. The third slit 34 is a narrow slit along the Y direction (third direction), and a plurality of the third slits 34 are arranged at equal intervals along the Y direction to form a third slit row 38. An interval between the third slits 34 in each third slit row 38 in the Y direction is narrow.

A plurality of third slit rows 38 are provided along the X direction. An X direction interval Xa between the third slit rows 38 is sufficiently narrow, and is set to be narrower than an interval Xb to be described later. The third slits 34 are disposed in a staggered manner between adjacent third slit rows 38. Among the third slits 34, end portion slits 34a at both ends in the Y direction in every other third slit row 38 reach the end portion in the Y direction. That is, the end portion slit 34a has a notch shape instead of a hole.

In this manner, a number of the third slit rows 38 including the plurality of third slits 34 are formed at narrow intervals along the Y direction (that is, the direction along the adjacent end portions 12Aa and 12Ba where the first chassis 12A and the second chassis 12B face each other), and the display assembly 16 is easily folded in the folding region R1 because the end portion slits 34a reach the end portion in the Y direction.

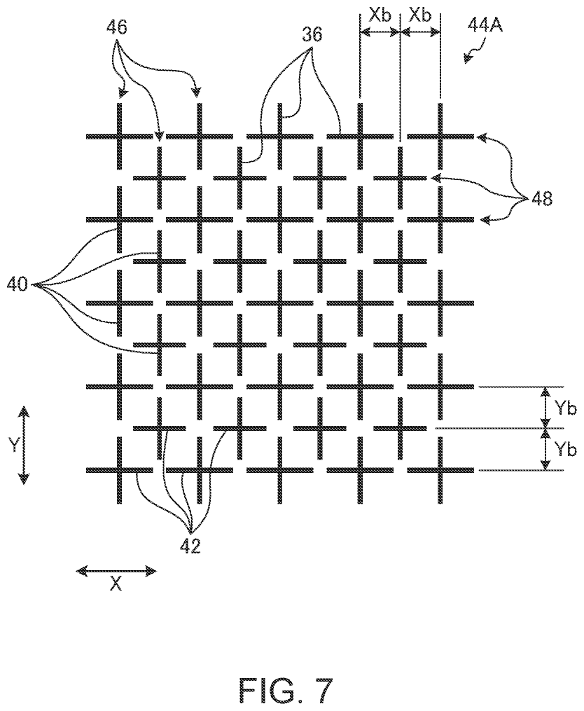

FIG. 7 is a partially enlarged plan view of a portion of the sheet-shaped member 22 that covers the regions RA and RB of the display 20. At this portion, a first pattern 44A is formed by the cross slits 36. In the cross slit 36, the first slit 40 along the Y direction (first direction) and the second slit 42 along the X direction (second direction) intersect to form a cross hole. A pattern formed by a number of cross slits 36 in the regions RA and RB is defined as the first pattern 44A. The first pattern 44A is provided at a portion excluding the folding region R1, that is, substantially the entire surface of the regions RA and RB (see FIG. 5). The first pattern 44A is not provided on the edge part facing the bezel member 28 (see FIG. 2), and the strength of the sheet-shaped member 22 is ensured. The first pattern 44A does not need to be provided on the entire surface of the portion excluding the folding region R1, and may be provided in a part (for example, either region RA or region RB) depending on the design conditions.

The first slit 40 is a narrow slit along the Y direction, and a plurality of the first slits 40 are arranged at equal intervals along the Y direction to form a first slit row 46. An interval between the first slits 40 in each first slit row 46 in the Y direction is narrow. A plurality of first slit rows 46 are provided along the X direction. An X direction interval Xb between the first slit rows 46 is wider than the interval Xa described above, and is slightly longer than half the length of the second slit 42, for example. The interval Xb may be randomly set according to the design conditions. The first slits 40 are disposed in a staggered manner between adjacent first slit rows 46.

The second slit 42 is a narrow slit along the X direction, and a plurality of the second slits 42 are arranged at equal intervals along the X direction to form a second slit row 48. The second slit 42 has the same length and width as the first slit 40. A plurality of second slit rows 48 are provided along the Y direction. A Y direction interval Yb between the second slit rows 48 is equal to the interval Xb described above. The second slits 42 are disposed in a staggered manner between adjacent second slit rows 48. That is, the directions of the plurality of first slit rows 46 and the plurality of second slit rows 48 forming a group differ by 90 degrees. In the first pattern 44A including the plurality of rows of the first slit rows 46 and the plurality of rows of the second slit rows 48, each of the first slits 40 and each of the second slits 42 form an intermittent lattice shape.

According to such the sheet-shaped member 22, as illustrated in FIG. 5, even in a case in which the pen tip of the pen input device 37 follows any of a trajectory T1 along the X direction, a trajectory T2 along the Y direction, and trajectories T3 and T4 along a diagonal direction, the frequency of going over the first slit 40 and the second slit 42 is almost the same, and a uniform and the appropriate resistance can be obtained regardless of the difference in the moving direction. In addition, such a resistance is similar to the case of writing on paper, and it is possible to perform pen input without feeling uncomfortable, and it is possible to give a preferable feel to the user.

In addition, in the first pattern 44A of the sheet-shaped member 22, the first slits 40 are disposed in a staggered manner between the adjacent first slit rows 46, and the second slits 42 are disposed in a staggered manner between the adjacent second slit rows 48. Thus, the interval between the cross slits 36 is narrow and tight, the frequency of going over the first slit 40 and the second slit 42 at each trajectory T1 to T4 is high, roughness is not easily felt and a more preferable feel can be given to the user.

Although a number of third slits 34 are provided along the Y direction instead of the first pattern 44 A, and there are no slits along the X direction, the X direction interval Xa between the third slit rows 38 consisting of the third slits 34 is narrow, which makes it difficult for the user to feel unevenness due to the moving direction of the pen.

Next, a pattern that replaces the first pattern 44A will be described. A second pattern 44B, a third pattern 44C, and a fourth pattern 44D described below are composed of the first slit 40 and the second slit 42 similar to those described above, and are formed in the same range as the first pattern 44A in the sheet-shaped member 22.

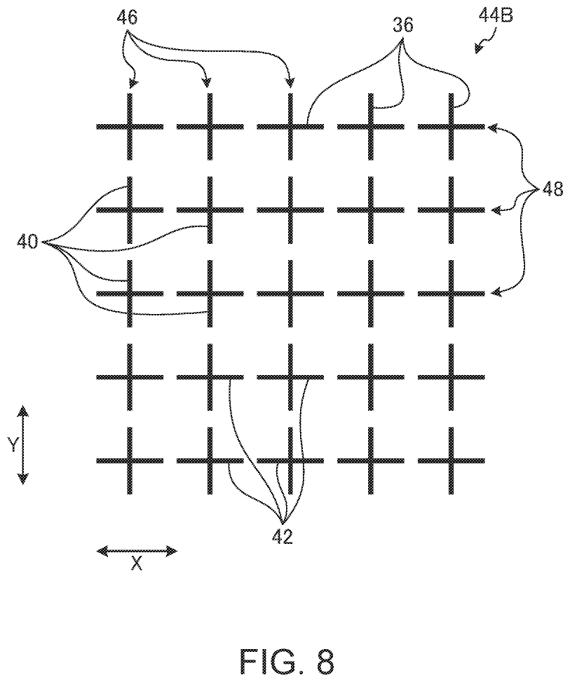

FIG. 8 is a view illustrating the second pattern 44B. The second pattern 44B is configured by a number of cross slits 36 similar to the first pattern 44A described above. However, in the adjacent first slit rows 46, the arrangement of the first slits 40 is aligned in the X direction, and in the adjacent second slit rows 48, the arrangement of the second slits 42 is aligned in the Y direction. Therefore, the cross slits 36 are also aligned in the X direction and the Y direction.

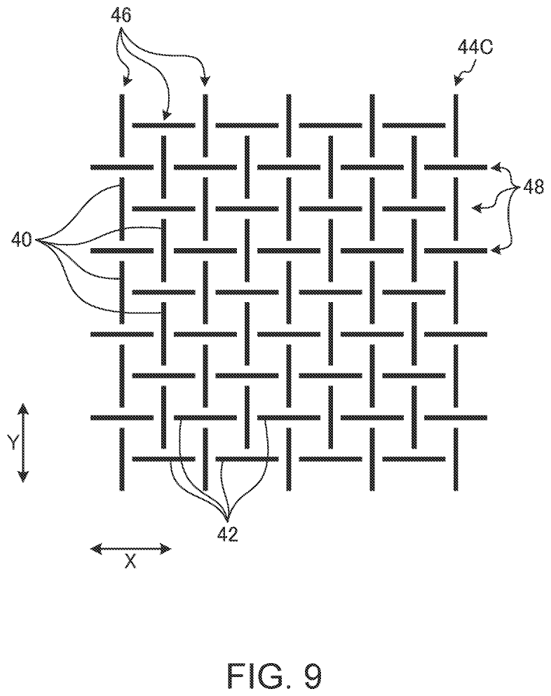

FIG. 9 is a view illustrating the third pattern 44C. Similar to the first pattern 44A described above, in the third pattern 44C, although the first slits 40 are disposed in a staggered manner between the adjacent first slit rows 46, and the second slits 42 are disposed in a staggered manner between the adjacent second slit rows 48, the first slit 40 and the second slit 42 do not intersect each other. That is, the first slit 40 is disposed between the two second slits 42 adjacent in the Y direction, and the second slit 42 is disposed between the two first slits 40 adjacent in the X direction.

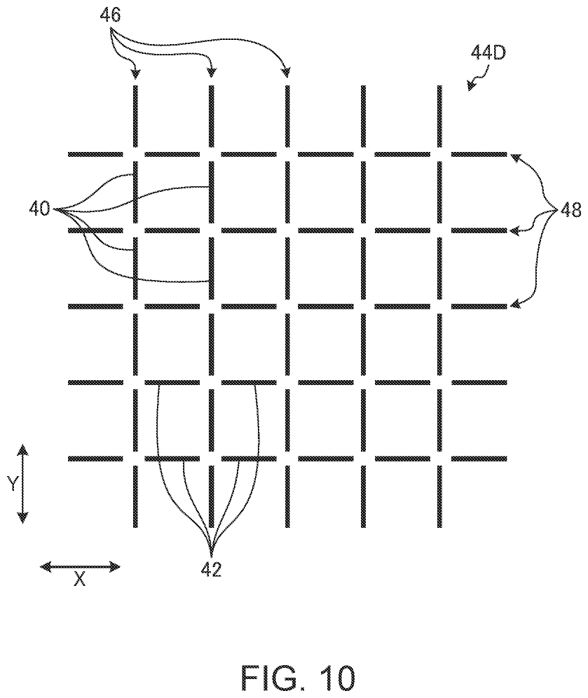

FIG. 10 is a view illustrating the fourth pattern 44D. In the fourth pattern 44D, in the adjacent first slit rows 46, the arrangement of the first slits 40 is aligned in the X direction, and in the adjacent second slit rows 48, the arrangement of the second slits 42 is aligned in the Y direction. In addition, the first slit 40 and the second slit 42 do not intersect each other.

Similar to the first pattern 44A, in such patterns 44B, 44C, and 44D, a uniform and the appropriate resistance can be obtained regardless of the difference in the moving direction of the pen. In the patterns 44A to 44C, the size of the intermittent lattice shape formed by the first slit 40 and each of the second slits 42 is determined by lengths of the first slit 40 and the second slit 42, and thus it is adjustable to provide the preferable resistance.

In each of the above examples, the first slit row 46 is along the Y direction and the second slit row 48 is along the X direction. However, the present invention is not limited to this, and for example, the first slit row 46 and the second slit row 48 may be tilted at 45 degrees with respect to the X direction and Y direction, respectively.

The present invention is not limited to the above-described embodiments, and it is needless to say that the present invention can be freely changed without departing from the gist of the present invention.

### DESCRIPTION OF SYMBOLS

10 electronic apparatus
12A first chassis
12B second chassis
16 display assembly
18 hinge mechanism
20 display
22 sheet-shaped member
30 touch panel
32 liquid crystal member
34 third slit
34a end slit
36 cross slit
37 pen input device
38 third slit row
40 first slit
42 second slit
44A first pattern
44B second pattern
44C third pattern
44D fourth pattern
46 first slit row
48 second slit row
R1 folding region

What is claimed:

1. An electronic apparatus comprising:
a first chassis;
a second chassis adjacent to the first chassis and relatively rotatably connected to the first chassis;
a display provided over the first chassis and the second chassis and having a folding region that is folded according to relative rotation of the first chassis and the second chassis; and
a sheet-shaped member having a flexibility and is fixed to a rear surface of the display to cover the rear surface, wherein
the sheet-shaped member is provided with a first slit row including a plurality of first slits arranged at equal intervals along a first direction and a second slit row including a plurality of second slits arranged at equal intervals in a second direction that is orthogonal to the first direction,
a plurality of the first slit rows are provided at equal intervals along the second direction,
a plurality of the second slit rows are provided at equal intervals along the first direction, and
in a pattern formed by the plurality of first slit rows and the plurality of second slit rows, the first slit and the second slit form an intermittent lattice shape.

2. The electronic apparatus according to claim 1, wherein
the pattern is provided at a portion excluding a portion that covers the folding region,
in the portion covering the folding region, a plurality of third slit rows are provided, the third slit row including third slits that are arranged at equal intervals along a third direction along an edge where the first chassis and the second chassis face each other, and
an interval between the third slit rows is narrower than an interval between the first slit rows and an interval between the second slit rows.

3. The electronic apparatus according to claim 2, wherein
the first slit and the second slit intersect each other and form a cross slit.

4. The electronic apparatus according to claim 3, wherein
the first slit and the second slit have a same length, and
intervals between the plurality of first slit rows and intervals between the plurality of second slit rows are equal.

5. The electronic apparatus according to claim 4, wherein
the first slits are disposed in a staggered manner between the adjacent first slit rows, and
the second slits are disposed in a staggered manner between the adjacent second slit rows.
